(19) United States
(12) Patent Application Publication
(10) Pub. No.: US 2009/0161386 A1
(43) Pub. Date: Jun. 25, 2009

(54) OPTICAL FILM AND BACKLIGHT MODULE USING SAME

(76) Inventors: WEI-HSUAN CHEN, Kaohsiung (TW); Cheng-Yi Lai, Kaohsiung (TW)

Correspondence Address: LEONG C LEI, PMB # 1008, 1867 YGNACIO VALLEY ROAD, WALNUT CREEK, CA, 94598, US

(21) Appl. No.: 12/124,179

(22) Filed: May 21, 2008

(30) Foreign Application Priority Data
Dec. 19, 2007 (TW) 096148571

(51) Int. Cl. F21V 7/04

(52) U.S. Cl. 362/620

(57) ABSTRACT

An optical film has at least one surface forming a dense and alternate arrangement of light condensation structures. The light condensation structures have a pyramid configuration having a major axis and a minor axis. Each light condensation structure forms four differently oriented light emission faces, so that the light condensation structure simultaneously condenses lights that are in vertical direction and horizontal direction with respect to the optical film and then emits the condensed lights. In this way, when the optical film is applied to a backlight module, the number of the optical film required by the backlight module to realize desired condensation of light can be reduced to thereby lower the manufacturing costs of the backlight module.

### BACKGROUND OF THE INVENTION

(a) Technical Field of the Invention

The present invention relates to an optical film and a backlight module using the optic film, and in particular to an optical film having a surface forming a dense and alternate arrangement of light condensation structures for simultaneously condensing light that emits from the optical film in vertical and horizontal directions.

(b) Description of the Prior Art

A liquid crystal display device requires a light source that is often realized by a backlight module. The backlight module is composed of a frame, a light source, a reflector film, a light guide board, and an optic film (including a diffusion lens film and a prism lens film). The last component of the backlight module that the light transmits before the light is emitted is the either the diffusion lens film or the prism lens film. The diffusion lens film functions to make the light diffused and thus homogenized, while the prism lens film functions to condense the light for enhancing the brightness of the light. These two elements play an important role in the backlight module. Especially, the prism lens film is of an important factor in determining the brightness performance of the backlight module, which in turn relates to the overall performance of the liquid crystal displays.

FIG. 1 of the attached drawings shows a conventional backlight module, which is broadly designated at 1 in FIG. 1. The conventional backlight module 1 comprises a frame 11, a reflector board 12, a light guide board 13, optical films 14, and a light source unit 15, which can be for example a cold cathode fluorescent lamp. The frame 11 has side walls 111, which defines therebetween a receiving space 112 that receives in sequence the reflector board 12 and the light guide board 13 therein. Arranged above the light guide board 13 is a plurality of optic films 14, which includes a diffusion film 141 and a prism lens film 142. The prism lens film 142 functions to redirect emitted light to have the light condensed in a desired direction. The diffusion film 141 serves to diffuse and thus homogenize the emitted light and also provides the function of covering.

The prism lens film 142 of the optical films 14 has a surface on which a plurality of prism-like fine ribs 1421 is formed. The prism-like ribs 1421 are arranged in straight lines on the surface of the prism lens film 142. In assembling the backlight module 1, two prism lens films 142 are arranged in such a way that the prism-like ribs 1421 thereof are mutually perpendicular to effect light condensation in different directions.

The conventional backlight module 1 uses two prism lens films 142 to meet the needs of light condensation for a liquid crystal display. However, the prism lens film 142 is costly. This makes the overall cost of the backlight module very high and also causes problems in the inventory of parts.

In view of the above discussed problems of the conventional prism lens film 142, it is desired to have an improved optical film that effects the same function of the prism lens film without those problems.

### SUMMARY OF THE INVENTION

The primary purpose of the present invention is to provide an optical film that overcomes the problem of the conventional device that require the simultaneous use of two optic films and that reduces the overall manufacturing cost of a backlight module.

A solution of the present invention for overcoming the above problems is an optical film, which has at least one surface on which a dense ad alternate arrangement of light condensation structures is formed. Each light condensation structure is of a pyramid configuration having a major axis and a minor axis and each light condensation structure forms four differently oriented light emission faces so that the light condensation structure simultaneously effects condensation of light transmitting therethrough in both a vertical direction and a horizontal direction before the light exits the optical film so as to realize omni-directional light condensation.

A secondary solution of the present invention is to provide an optical film having at least one surface on which a dense and alternate arrangement of light condensation structures is formed. The light condensation structures are of a pyramid configuration having a major axis and a minor axis. Each light condensation structure forms four differently oriented light emission faces, each of which is of a convex surface to expand a viewing angle and thus enhancing homogenization of light emission.

A further solution of the present invention is to provide a backlight module comprising at least a frame, a reflector film, a light guide board, and a light source. The frame receives in sequence the reflector film and the light guide board. Arranged above the light guide board are a diffusion film and a piece of the above described optical film. The optical film comprises a prism lens film having a light condensation structure that forms four differently oriented light emission faces for simultaneously condensing lights that are vertical and horizontal with respect to the prism lens film and then emitting the lights. Thus, by applying the prism lens film to the backlight module, the number of required prism lens film can be reduced to realize cost saving and simplified assembling.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a conventional backlight module;

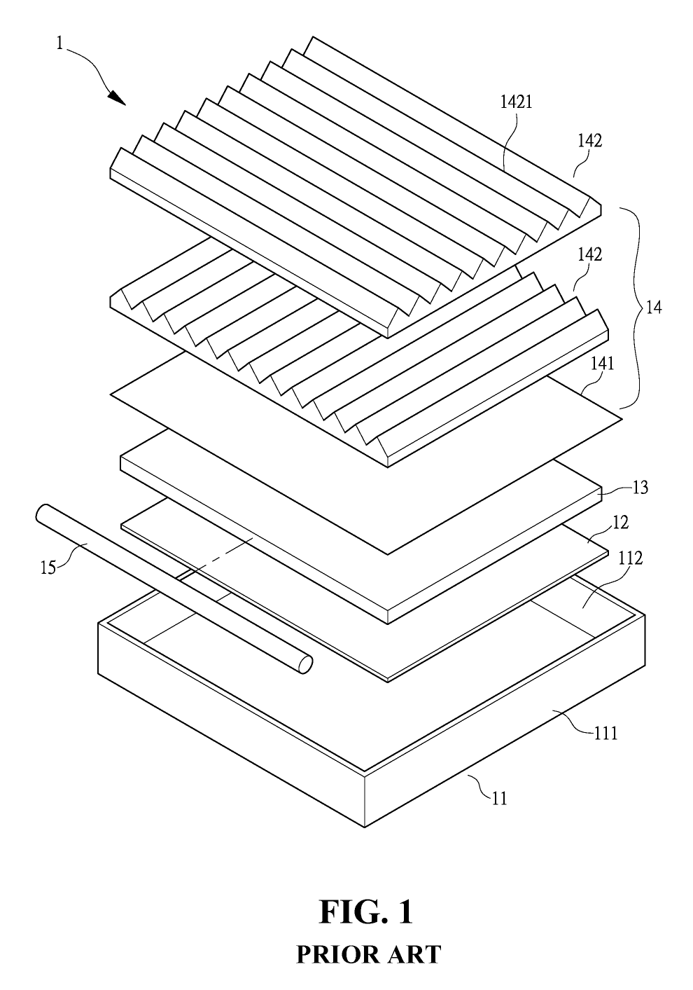

FIG. 2 is a perspective view of an optical film constructed in accordance with the present invention;

FIG. 3 is a schematic view illustrating transmission of light through a light condensation structure of the optical film in accordance with the present invention;

FIG. 4 is a perspective view of an optical film constructed in accordance with a different embodiment of the present invention; and

FIG. 5 is an exploded view of a backlight module in which the optical film of the present invention is applied.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

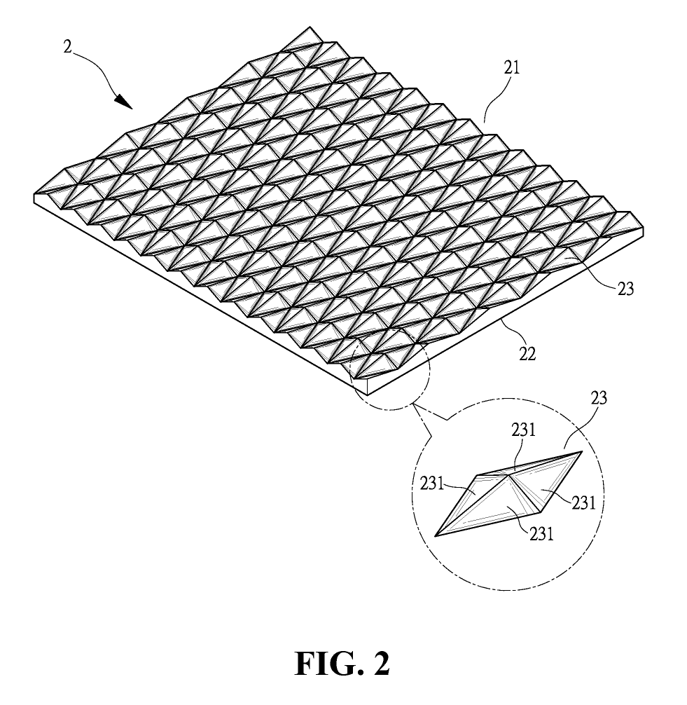

With reference to the drawings and in particular to FIG. 2, an optical film constructed in accordance with the present invention is generally designated at 2. The optical film 2 is made of a material of excellent light transmittance. The optical film 2 has a first surface 21 and a second surface 22. At least one of these surfaces 21, 22 forms a dense and alternate arrangement of light condensation structures 23 that projects above the surface of the optical film 2. The light condensation structures 23 have a pyramid configuration having a major (long) axis and a minor (short) axis. Each light condensation structure 23 forms four differently oriented light emission faces 231. By means of the pyramid configuration of the light condensation structure 23, light transmitting through the light condensation structure 23 can be simultaneously condensed in both a vertical direction (the major axis) and a horizontal direction (the minor axis) before the light emits from the light emission faces 231.

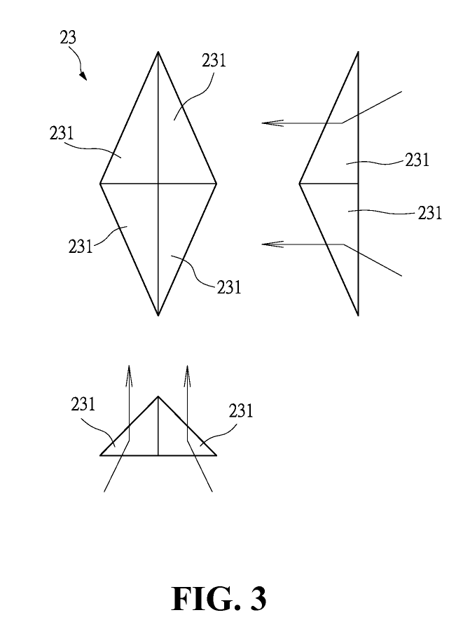

Also referring to FIG. 3, the effect that the light condensation structure 23 of the optical film 2 may have on the light transmitting therethrough is that when the light entering the optical film 2 through a surface thereof is to emit from the light emission faces 231 of the light condensation structure 23, the differently oriented light emission faces 231 that are formed with respect to the vertical direction (the major axis) and the horizontal direction (the minor axis) of the pyramid can cause the light to refract through the light condensation structure 23 to thereby realize emission of light in two different directions, providing the optical film 2 with the function of light condensation.

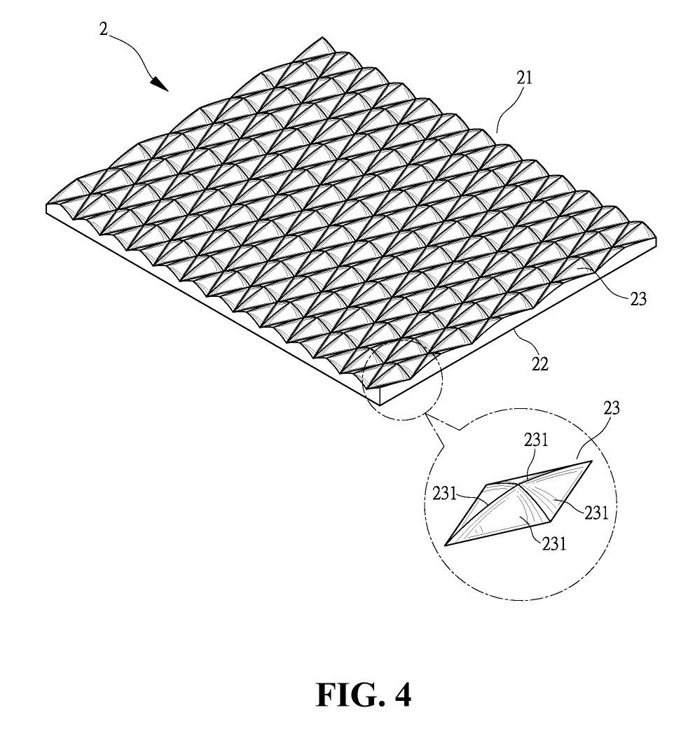

Also referring to FIG. 4, to practice the optical film 2 of the present invention in a different way, the light emission faces 231 of the light condensation structure 23 are made convex curved so that the light 2 emitting therefrom is provided with an enlarged emission angle, which leads to an increased viewing angle and also enhances homogenization of the emitted light.

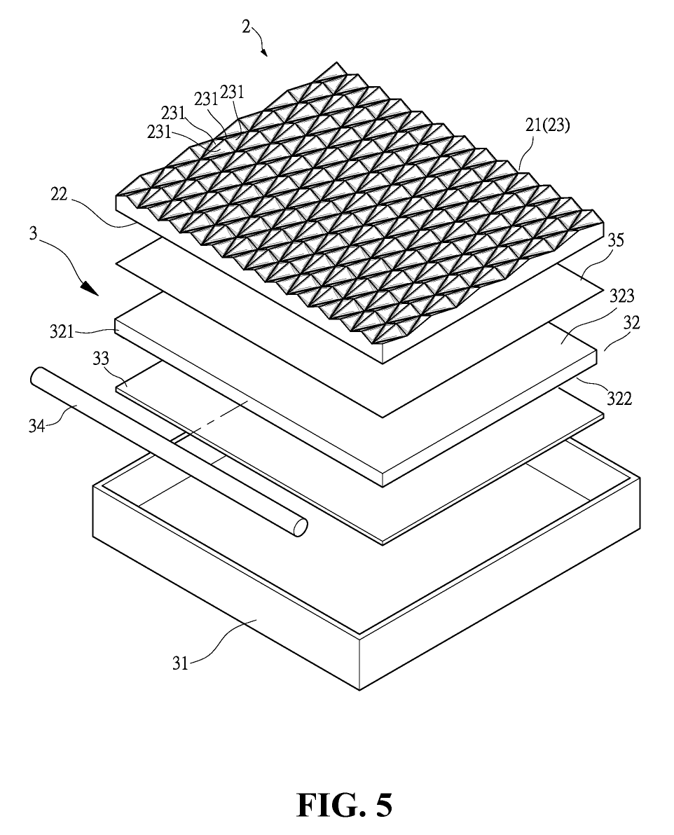

Also referring to FIG. 5, an application of the optical film of the present invention in a backlight module 3 is illustrated. The backlight module 3 comprises at least a frame 31, and a light guide board 32 made of a material of excellent light transmittance, such as polymethylmethacrylate (PMMA), a reflector film 33, and a light source 34. The light guide board 22 has at least a light entrance face 321 for receiving light from the light source 34 and guiding the transmission of the light into the light guide board 32; a reflection face 322 for reflecting the light entering the light guide board 32, the reflector film 33 being arranged outside the reflection face 322 of the light guide board 32 for reflection light leaking through the reflection face 322 back into the light guide board 32; a light emission face 323 for emitting the light outward from the light guide board 32, a diffusion film 35 being arranged above the light emission face 323 for homogenizing the light leaving the light guide board 32. The optical film 2 of the present invention is arranged outside the light emission face 323 of the light guide board 32 with the second surface 22 of the optical film 2 facing the light emission face 323 of the light guide board 32 and major axis of the light condensation structures 23 of the optical film 2 being perpendicular to the arrangement direction of the light source 34 of the backlight module 3. As such, a single optical film 2 is effective to condense light that has already been condensed in a given direction by the light guide board 32 in two different directions, namely the vertical direction (the major axis) and the horizontal direction (the minor axis), by means of the light emission faces 21 of the optical film 2. In this way, the number of the optical film 2 that is required to carry out the desired light condensation for the backlight module 3 can be reduced and thus the assembling is simplified and the cost is reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optical film comprising a first surface and a second surface, at least one of which forms a dense arrangement of light condensation structures, wherein the light condensation structures have a pyramid configuration having a major axis and a minor axis so that each light condensation structure has four differently oriented light emission faces, whereby the light condensation structure simultaneously condenses lights that are in vertical direction and horizontal direction with respect to the optical film and then emits the condensed lights.

2. The optical film as claimed in claim 1, wherein the light condensation structures are of an alternate arrangement.

3. The optical film as claimed in claim 1, wherein the light emission faces of the light condensation structures are of convex curved faces.

4. A backlight module comprising:
a frame receiving in sequence a reflector board and a light guide board therein;
the light guide board having a light entrance face, a light emission face, and a reflection face, the light emission face being provided with a diffusion film and an optical film;
the reflector board being provided to the reflection face of the light guide board; and
a light source;
wherein the optical film comprises a first surface and a second surface, at least one of which forms a dense arrangement of light condensation structures, the light condensation structures having a pyramid configuration having a major axis and a minor axis so that each light condensation structure has four differently oriented light emission faces, whereby the light condensation structure simultaneously condenses lights that are in vertical direction and horizontal direction with respect to the optical film and then emits the condensed lights.

5. The backlight module as claimed in claim 4, wherein the light condensation structures are of an alternate arrangement.

6. The backlight module as claimed in claim 4, wherein the light emission faces of the light condensation structures are of convex curved faces.
